(19) United States
(12) Patent Application Publication
(10) Pub. No.: US 2018/0190416 A1
(43) Pub. Date: Jul. 5, 2018

(54) MAGNETIC MATERIAL AND MAGNETIC COMPONENT EMPLOYING THE SAME

(71) Applicant: INDUSTRIAL TECHNOLOGY RESEARCH INSTITUTE, Hsinchu (TW)

(72) Inventors: Chun-Pin WU, Tainan City (TW); Mean-Jue TUNG, Jincheng Township (TW); Wen-Song KO, Hsinchu City (TW)

(73) Assignee: INDUSTRIAL TECHNOLOGY RESEARCH INSTITUTE, Hsinchu (TW)

(21) Appl. No.: 15/395,577

(22) Filed: Dec. 30, 2016

(51) Int. Cl. H01F 1/16; H01F 17/00; H01F 1/147; H01F 41/04; H01F 1/37; H01F 27/28; H01B 1/20

(52) U.S. Cl. CPC H01F 1/16; H01F 17/0013; H01F 1/14791; H01F 41/041; H01F 2027/2809; H01F 27/2804; H01F 41/046; H01B 1/20; H01F 1/37

(57) ABSTRACT

A magnetic material is provided. The magnetic material includes a core portion consisting of above 99 wt % of Fe, based on the total weight of the core portion. An alloy layer including a FeM alloy is disposed on the surface of the core portion, wherein M is Cr, Si, Al, Ti, Zr, or a combination thereof. An oxide layer including M and an oxide of M is disposed on the surface of the alloy layer. A magnetic component is also provided. The magnetic component includes a sintered product of the magnetic material and a metal.

### TECHNICAL FIELD

The present disclosure relates to a magnetic material and a magnetic component employing the same.

### BACKGROUND

As demand grows for the miniaturization of electronic devices such as smartphones and tablet computers, inductors are also becoming smaller, with accordingly increased frequency and saturation current. So far, in response to this demand, the metal oxides (such as iron oxides) commonly used as magnetic materials in inductors have been replaced by metals in studies to improve characteristics such as magnetic permeability, saturation magnetization, and saturation current.

Currently, most of the metals used as magnetic materials are alloys, which have poorer magnetic characteristics than pure metal materials (for example, saturation magnetization (emu/g): FeSi=205, NiFeMo=8˜160<pure Fe=217). When applied to multilayer inductors, magnetic materials have to be co-fired with silver and cannot form a closed circuit with silver, but pure metals can easily be partially oxidized by a high temperature co-firing process, which results in a decrease of its magnetic characteristics and a loss of its inductor characteristics because of the closed circuit formed with silver.

Therefore, a magnetic material with improved performance is currently needed, and one that can be applied not only to the traditional wire-wound inductor, but also to co-fired type multilayer inductors or other magnetic components.

### SUMMARY

According to an embodiment, the present disclosure provides a magnetic material, including a core portion including above 99 wt % of Fe, based on the total weight of the core portion; an alloy layer disposed on the surface of the core portion, including a FeM alloy, wherein M is Cr, Si, Al, Ti, Zr, or a combination thereof; and a hybrid layer disposed on the surface of the alloy layer, including M and an oxide of M.

According to an embodiment, the present disclosure provides a magnetic material, including a core portion including above 99 wt % of Fe, based on the total weight of the core portion; a first passivation layer disposed on the surface of the core portion, including an oxide of a FeM alloy, wherein M is Cr, Si, Al, Ti, Zr, or a combination thereof; and a second passivation layer disposed on the surface of the first passivation layer, including an oxide of M.

According to another embodiment, the present disclosure provides a magnetic component, including a sintered product of the aforementioned magnetic material and a metal.

A detailed description is given in the following embodiments with reference to the accompanying drawings.

### BRIEF DESCRIPTION OF DRAWINGS

The present disclosure can be more fully understood by reading the subsequent detailed description and examples with references made to the accompanying drawings, wherein:

FIG. 1 illustrates a cross-sectional schematic diagram of the magnetic material according to an embodiment of the present disclosure.

FIG. 2 illustrates a cross-sectional schematic diagram of the magnetic material according to another embodiment of the present disclosure.

FIG. 3A illustrates schematic diagrams of intermediate processes for manufacturing the magnetic material according to an embodiment of the present disclosure.

FIG. 3B illustrates schematic diagrams of intermediate processes for manufacturing the magnetic material according to an embodiment of the present disclosure.

FIG. 3C illustrates schematic diagrams of intermediate processes for manufacturing the magnetic material according to an embodiment of the present disclosure.

FIG. 4 illustrates the magnetic permeability of the magnetic materials of some comparative examples and embodiments of the present disclosure.

FIG. 5 illustrates the magnetic permeability of the magnetic materials of some comparative examples and embodiments of the present disclosure.

FIG. 6A illustrates a cross-sectional schematic diagram of the magnetic material of an embodiment of the present disclosure observed by using a scanning electron microscope (SEM).

FIG. 6B is an enlarged diagram of the region indicated by the square frame shown in FIG. 6A.

FIG. 7A illustrates a cross-sectional schematic diagram of the magnetic material of another embodiment of the present disclosure observed by using a scanning electron microscope (SEM).

FIG. 7B is an enlarged diagram and composition analysis result of the region indicated by the square frame shown in FIG. 7A.

FIG. 8A illustrates a cross-sectional schematic diagram of the magnetic component of comparative example 3 of the present disclosure observed by using a scanning electron microscope (SEM).

FIG. 8B illustrates a cross-sectional schematic diagram of the magnetic component of an embodiment of the present disclosure observed by using a scanning electron microscope (SEM).

FIG. 8C illustrates a cross-sectional schematic diagram of the magnetic component of another embodiment of the present disclosure observed by using a scanning electron microscope (SEM).

### DETAILED DESCRIPTION

The following provides many different embodiments according to different features of the present disclosure. In the present disclosure, specific components and arrangements are described for simplicity. However, the present disclosure is not limited to these embodiments. For example, the formation of a first component on a second component in the description may include embodiments in which the first and second components are formed in direct contact, and may also include embodiments in which additional components may be formed between the first and second components, such that the first and second components may not be in direct contact. In addition, for the purpose of simplicity and clarity, the present disclosure may repeat reference numerals and/or letters in the various examples. However, it does not in itself dictate a specific relationship between the various embodiments and/or configurations discussed.

The embodiments of the present disclosure provide a magnetic material with high magnetic permeability and high saturation magnetization, and a magnetic component obtained from co-firing the magnetic materials and metals. The problem of magnetic characteristics decreasing because of the oxidation of inner metal materials can be avoided by protecting the inner metal materials with a metal alloy passivation layer disposed on the surface of the magnetic material.

An embodiment of the present disclosure provides a magnetic material 1, as shown in FIG. 1, including a core portion 10; an alloy layer 12 disposed on the surface of the core portion 10; and a hybrid layer 14 disposed on the surface of the alloy layer 12. The particle size of the magnetic material 1 may be, for example, 0.5˜50 μm or 50˜110 μm.

The core portion 10 includes above 99 wt % of Fe, based on the total weight of the core portion 10. In one embodiment, the core portion 10 only includes metal element Fe, i.e. 100 wt % of Fe. In another embodiment, the core portion 10 may include Fe and an oxide of Fe, and the oxide of Fe may include ferrous oxide (FeO), ferric oxide (Fe₂O₃), ferroferric oxide (Fe₃O₄), or a combination thereof. In this embodiment, the amount of Fe may be above 99 wt %, for example, 99 wt %, 99.5 wt %, or 99.99 wt %, and the amount of the oxide of Fe may be less than 1 wt %, for example, 0.01 wt %, 0.05 wt %, or 1 wt %, based on the total weight of the core portion 10.

The alloy layer 12 may include a FeM alloy, and M is Cr, Si, Al, Ti, Zr, or a combination thereof. The amount of M in the alloy layer 12 may be 5˜80 wt %, based on the total weight of the FeM alloy. If the amount of M is too low, for example, less than 5 wt %, it is easy for the core portion to form oxides which results in a decrease of all of the magnetic characteristics. If the amount of M is too high, for example, more than 80 wt %, all of the magnetic characteristics will decrease too much since the magnetic characteristics of M are poorer than that of Fe. The thickness of the alloy layer 12 may be 0.05˜10 μm, for example, 0.1 μm, 0.3 μm, 1.5 μm, 3 μm, or 5 μm.

The hybrid layer 14 may include M and an oxide of M, and M is Cr, Si, Al, Ti, Zr, or a combination thereof. The thickness range of the hybrid layer 14 is 0.05˜10 μm, for example, 0.1 μm, 0.3 μm, 1.5 μm, 3 μm, or 5 μm. If the thickness of the hybrid layer 14 is too thin, for example, less than 0.05 μm, a passivation layer cannot be formed after the subsequent sintering at 450·900° C., and therefore an effective magnetic component cannot be formed by co-firing with silver. If the thickness of the hybrid layer 14 is too thick, for example, more than 10 μm, all of the magnetic characteristics will decrease too much since the magnetic characteristics of M and the oxide of M in the thickness of the hybrid layer 14 are poorer than that of Fe. At a microscopic level, the hybrid layer 14 may include a plurality of granular protruding structures.

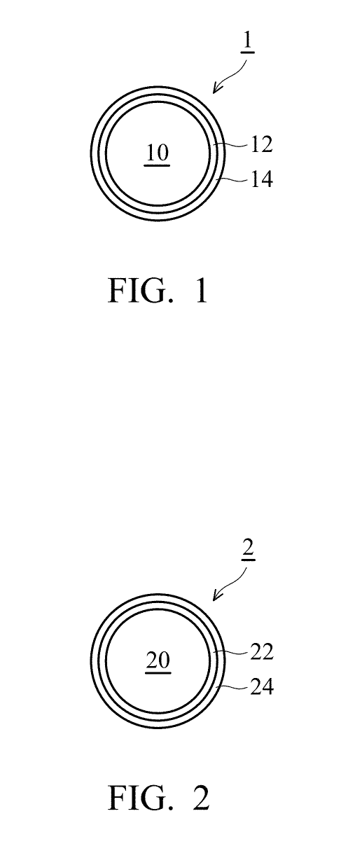

Another embodiment of the present disclosure provides a magnetic material 2, as shown in FIG. 2, including a core portion 20; a first passivation layer 22 disposed on the surface of the core portion 20; and a second passivation layer 24 disposed on the surface of the first passivation layer 22. The particle size of the magnetic material 2 may be, for example, 0.5˜50 μm or 50˜110 μm.

The core portion 20 includes above 99 wt % of Fe, based on the total weight of the core portion 20. In one embodiment, the core portion 20 only includes metal element Fe, i.e. 100 wt % of Fe. In another embodiment, the core portion 20 may include Fe and an oxide of Fe, and the oxide of Fe may include ferrous oxide (FeO), ferric oxide (Fe₂O₃), ferroferric oxide (Fe₃O₄), or a combination thereof. In this embodiment, the amount of Fe may be above 99 wt %, for example, 99 wt %, 99.5 wt %, or 99.99 wt %, and the amount of the oxide of Fe may be less than 1 wt %, for example, 0.01 wt %, 0.05 wt %, or 1 wt %, based on the total weight of the core portion 20.

The first passivation layer 22 may include an oxide of a FeM alloy, and M is Cr, Si, Al, Ti, Zr, or a combination thereof. The amount of M in the first passivation layer 22 may be 5˜80 wt %, based on the total weight of the oxide of the FeM alloy. If the amount of M is too low, for example, less than 5 wt %, it is easy for the core portion to form oxides which results in a decrease of all of the magnetic characteristics. If the amount of M is too low, for example, more than 80 wt %, all of the magnetic characteristics will decrease too much since the magnetic characteristics of M are poorer than that of Fe. The thickness of the first passivation layer 22 may be 0.05˜10 μm, for example, 0.1 μm, 0.3 μm, 1.5 μm, 3 μm, or 5 μm.

The second passivation layer 24 may include an oxide of M, and M is Cr, Si, Al, Ti, Zr, or a combination thereof. The thickness range of the second passivation layer 24 is 0.05˜10 μm, for example, 0.1 μm, 0.3 μm, 1.5 μm, 3 μm, or 5 μm. If the second passivation layer 24 is too thin, for example, less than 0.05 μm, when the magnetic material is co-fired with silver, silver easily diffuses and forms a closed circuit, which causes the magnetic component failure. If the thickness of the second passivation layer 24 is too thick, for example, more than 10 μm, all of the magnetic characteristics will decrease too much since the magnetic characteristics of M and the oxide of M in the second passivation layer 24 are poorer than that of Fe. At a microscopic level, the second passivation layer 24 may include a plurality of granular protruding structures.

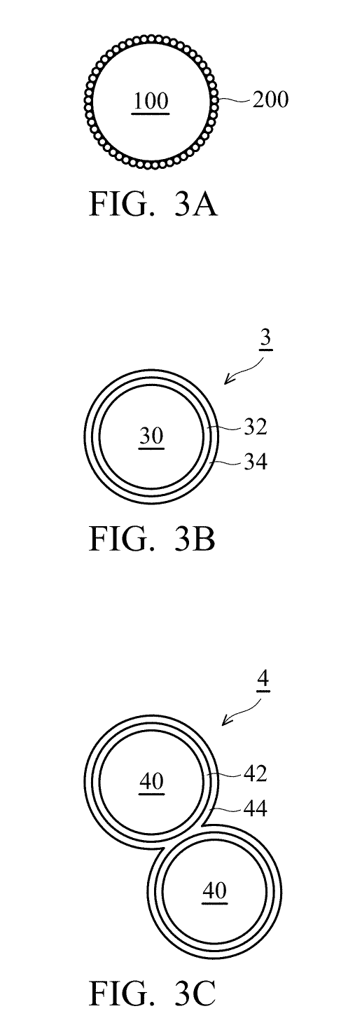

FIGS. 3A-3C illustrate schematic diagrams of intermediate processes for manufacturing the magnetic materials 3, 4 according to an embodiment of the present disclosure. Below, the manufacture processes of magnetic materials 3, 4 are described according to an embodiment of the present disclosure. However, the description of the embodiment is only for the purpose of explanation. The manufacturing methods of the magnetic materials of the present disclosure are not limited to this embodiment.

First, the second particles 200 used as the material of outer layer are ground to, for example, 0.02˜10 μm. Then, the ground second particles 200 and the first particles 100 used as the core portion were mixed by a dry-type ball mill to let the second particles 200 evenly cover on the surface of the first particles 100, as shown in FIG. 3A. There may be voids between second particles 200, such that the surface of first particles 100 may not be completely covered. The first particles 100 and the second particles 200 may be mixed by other appropriate physical methods, such as shearing and stirring mixing and high speed stirring and mixing. A chemical method may also be used to let the second particles 200 cover on the surface of the first particles 100; however, additional cleaning steps are needed, which may produce problems with remaining solvent and materials easily becoming oxidized.

The first particles 100 may be Fe, an oxide of Fe, or a combination thereof, for example, ferrous oxide (FeO), ferric oxide (Fe₂O₃), ferroferric oxide (Fe₃O₄), or a combination thereof. When the first particles 100 are Fe, the particle size may be 0.5˜100 μm. When the first particles 100 are an oxide of Fe, the particle size may be 0.5˜100 μm. The second particles 200 may be an oxide of M or a hydroxide of M, and M is Cr, Si, CrSi, CrSiFe, Al, FeCr, FeSi, FeAl, Ti, Zr, or a combination thereof. The particle size of the second particles 200 may be 0.02˜10 μm. When the first particles 100 are mixed with the second particles 200, the weight ratio may be 200: 1˜5:1.

Next, the above mixture of the first particles 100 and the second particles 200 is put in a hydrogen atmosphere of about 5% at about 600˜1200° C. to react for about 2-15 hours to form the magnetic material 3.

During the hydrogenation process, reduction reactions occur at a part of the second particles 200, and the oxide of M is reduced to metal element M. Metal element M diffuses into the first particles 100 and forms alloys with the component of the first particles 100, for example, FeM alloy. Furthermore, an alloy layer 32 is formed on the surface of the first particles 100. The thickness of the alloy layer 32 may be 0.05˜10 μm, depending on the time of hydrogenation reaction. The time of hydrogenation reaction may be 2˜15 hours. If the time of the hydrogenation reaction is too short, the thickness of the resulting alloy layer 32 will be too thin, and therefore it cannot be oxidized to form a passivation layer by the subsequent sintering. The core portion 30 will be easily oxidized, resulting in a decrease of magnetic characteristics. The remaining metal elements M which do not diffuse into the first particles 100 or the non-reduced oxide of M will be remained on the surface of the alloy layer 32, which is called a hybrid layer 34 hereinafter. The inner portion of the alloy layer 32 is called the core portion 30. No matter whether the first particles 100 in the embodiment are Fe or oxide of Fe, after the hydrogenation reaction, almost all of the oxides of Fe are reduced to Fe. Thus, the core portion 30 has Fe as the main component, and therefore has good magnetic characteristics of pure metal.

Therefore, the magnetic material 3 produced after the hydrogenation and reduction reactions includes a core portion 30 with Fe as the main component (above 99 wt %), an alloy layer 32 disposed on the surface of the core portion 30, and a hybrid layer 34 disposed on the surface of the alloy layer 32, as shown in FIG. 3B.

It should be noted that, compared to the magnetic materials using an alloy as the whole core portion to make the core portion insulate from the external environment, the magnetic materials of the present disclosure include merely a thin alloy layer on the surface of the core portion obtained by the above hydrogenation and reduction reactions, and may achieve the purpose of making the core portion resistant to oxidation, which can decrease magnetic characteristics. Also, it can be co-fired with silver at 450˜900° C. In addition, in using the above thin alloy layer to protect the inner core portion, the present disclosure uses Fe or uses Fe and a very small amount of oxide of Fe (about less than 1 wt %) to be the core portion. Therefore, compared to the magnetic materials using alloy as the whole core portion, the present disclosure significantly enhances the magnetic characteristics such as the whole saturation magnetization.

Next, the magnetic material 3 is put in an air atmosphere at about 450˜900° C. to be sintered for about 1˜5 hours to form the magnetic material 4.

After the above sintering process, the alloy in the alloy layer 32 is further oxidized to an oxide of alloy and a first passivation layer 42 is formed. The metal element M in the hybrid layer 34 is further oxidized to an oxide of M and a second passivation layer 44 is formed. Therefore, the magnetic material 4 produced after the sintering includes the core portion 40, the first passivation layer 42 disposed on the surface of the core portion 40, and the second passivation layer 44 disposed on the surface of the first passivation layer 42. Also, after the sintering, the magnetic materials 4 may combine with each other to form an aggregation of the magnetic materials 4 through the second passivation layer 44, as shown in FIG. 3C. However, it should be realized that although only an aggregate of two magnetic materials 4 is drawn in FIG. 3C, in some embodiments, the magnetic materials 4 may exist in the form of an aggregate of more magnetic materials 4. Alternatively, in other embodiments, the magnetic materials 4 exist in the form of a monomer instead of combining with each other, as shown in FIG. 2.

Another embodiment of the present disclosure provides a magnetic component, including a sintered product of a magnetic material and a metal. The magnetic material may be the aforementioned magnetic material 1 or magnetic material 2. The metal used may include silver, copper, or a combination thereof. In the sintered product, the magnetic material may be the powder monomer, the debris of the powder monomer, the aggregate of the powder monomer, or a combination thereof, of the magnetic material 1 or magnetic material 2.

In one embodiment, silver may be co-fired with the magnetic material 1 or the magnetic material 2. The temperature of the sintering may be 450˜900° C. Under such conditions, because the passivation layer will be self-formed, there is no need to add organic substances as the insulating material. While organic substances are used in an insulating layer, the insulating layer will lose the insulation function after undergoing high temperature (carbon or carbon dioxide gas is formed), causing the magnetic material to fail. However, the temperature of the co-firing of the magnetic material and the metal may be adjusted according to the characteristics of the oxide of the outer layer of the magnetic material or the melting points of different metal materials, as long as there is a passivation layer formed between the magnetic material and the metal.

The magnetic component may include multilayer inductors, wire-wound inductors, or electromagnetic interference (EMI) inhibition components. However, the magnetic components described in the present disclosure are not limited to these components. In addition, according to different types of magnetic component, the manufacturing methods are also different. Take multilayer inductors for example: the magnetic material 1 or the magnetic material 2 may be mixed evenly with slurry, and then be coated to form a thin film. Next, the metal wiring is printed on the thin film by using a method like screen printing. Then, the thin film is put in an air atmosphere at about 450˜900° C. to be co-fired for about 0.5˜10 hours to form the multilayer inductor. Similarly, the magnetic material 1 or the magnetic material 2 may be applied to other types of magnetic components. Since various manufacturing methods of the magnetic component are well-known to those skilled in the art and may be modified and used by those skilled in the art, they are not discussed herein to avoid unnecessary repetition.

The magnetic materials provided by the present disclosure use Fe, or use Fe and very small amount of oxides of Fe (about less than 1 wt %) to be the core portion. Merely by using the thin alloy layer and the thin passivation layer outside the core portion, the purpose of insulating the core portion from the external environment can be achieved. Compared to the magnetic material using alloy as the whole core portion, the present disclosure significantly enhances the magnetic characteristics such as the whole saturation magnetization. Therefore, the magnetic materials provided by the present disclosure have high magnetic permeability and high saturationmagnetization, and can be co-fired with metals to produce a self-formed passivation layer to form a workable magnetic component. In addition, the magnetic components formed from the magnetic materials provided by the present disclosure also have advantages such as high magnetic permeability and high saturation magnetization.

The various Embodiments and Comparative Examples are listed below to illustrate the magnetic materials provided by the present disclosure and the characteristics thereof.

### COMPARATIVE EXAMPLE 1

### Embodiment 1

Comparative Example 1 and Example 1 were prepared according to the amount shown in Table 1. Except for Comparative Example 1-1, the first particles and the second particles were mixed by a dry-type ball mill. The obtained mixture was then used to form the magnetic material according to the process shown in Table 1.

The magnetic permeability of each particle of Comparative Examples 1-1˜1-5 and Examples 1-1˜1-8 was measured. The results are shown in Table 2.

TABLE 1

| First particle/ | | | | |
|---|---|---|---|---|
| weight (g)/ | Second particle/weight (g)/distribution of the particle size (μm) | | | |
| particle size (μm) | Component 1 | Component 2 | Component 3 | process |

Comparative Example 1

| | | | | | |
|---|---|---|---|---|---|
| 1-1 | Fe/50/50 | — | — | — | none |
| 1-2 | Fe/50/50 | Cr₂O₃/0.5/0.1~0.5 | — | — | none |
| 1-3 | Fe₂O₃/50/0.5 | Cr₂O₃/1/0.1~0.5 | — | — | none |
| 1-4 | FeSi/50/5 | Cr₂O₃/3.5/0.1~0.5 | — | — | 1 |
| 1-5 | NiFeMo/50/10 | Cr₂O₃/3.5/0.1~0.5 | — | — | 1 |

Example 1

| | | | | | |
|---|---|---|---|---|---|
| 1-1 | Fe/50/50 | Cr₂O₃/0.5/0.1~0.5 | — | — | 1 |
| 1-2 | Fe/50/50 | CrO₃/1/0.1~0.5 | — | — | 1 |
| 1-3 | Fe/50/50 | Cr₂O₃/3.5/0.1~0.5 | — | — | 1 |
| 1-4 | Fe/50/50 | Cr₂O₃/3.5/0.2~1.3 | — | — | 1 |
| 1-5 | Fe₂O₃/50/0.5 | Cr₂O₃/1/0.1~0.5 | — | — | 1 |
| 1-6 | Fe/50/50 | Al(OH)₃/5.3/2.5 | — | — | 1 |
| 1-7 | Fe/50/50 | Cr₂O₃/3.5/0.1~0.5 | SiO₂/1.5/0.1 | — | 1 |
| 1-8 | Fe/50/50 | Cr₂O₃/3.5/0.1~0.5 | SiO₂/1.5/0.1 | Fe₂O₃/0.5/0.5 | 1 |

Note:
process 1 represents a hydrogenation condition of 5% H₂, 900° C., 12 hrs.

TABLE 2

| | |
|---|---|
| magnetic permeability | magnetic permeability |
| @1 MHz | @10 MHz |

Comparative Example 1

| | | |
|---|---|---|
| 1-1 | 26 | 5 |
| 1-2 | 36 | 25 |
| 1-3 | 0.6 | 1 |
| 1-4 | 9 | 9 |
| 1-5 | 18 | 17 |

Example 1

| | | |
|---|---|---|
| 1-1 | 43 | 27 |
| 1-2 | 41 | 31 |
| 1-3 | 29 | 23 |
| 1-4 | 34 | 26 |
| 1-5 | 35 | 23.5 |
| 1-6 | 18 | 15 |
| 1-7 | 15 | 14 |
| 1-8 | 14 | 13 |

### COMPARATIVE EXAMPLE 2

### Example 2

Comparative Example 2 and Example 2 were prepared according to the content shown in Table 3. Except for Comparative Example 2-1, the first particles and the second particles were mixed by a dry-type ball mill. The obtained mixture was then used to form the magnetic material according to the process shown in Table 3.

The magnetic permeability of each particle of Comparative Examples 2-1˜2-2 and Examples 2-1˜2-8 was measured. The results are shown in Table 4.

TABLE 3
Comparative Example 2

| | First particle/ | | | | |
|---|---|---|---|---|---|
| | weight (g)/ | Second particle/weight (g)/distribution of the particle size (μm) | | | |
| | particle size (μm) | Component 1 | Component 2 | Component 3 | process |
| 2-1 | Fe/50/50 | — | — | — | 2 |
| 2-2 | Fe/50/50 | Cr₂O₃/0.5/0.1~0.5 | — | — | 2 |

Example 2

| | First particle/ | | | | |
|---|---|---|---|---|---|
| | weight (g)/ | Second particle/weight (g)/distribution of the particle size (μm) | | | |
| number | particle size (μm) | Component 1 | Component 2 | Component 3 | process |
| 2-1 | Fe/50/50 | Cr₂O₃/0.5/0.1~0.5 | — | — | 1 + 2 |
| 2-2 | Fe/50/50 | Cr₂O₃/1/0.1~0.5 | — | — | 1 + 2 |
| 2-3 | Fe/50/50 | Cr₂O₃/3.5/0.1~0.5 | — | — | 1 + 2 |
| 2-4 | Fe/50/50 | Cr₂O₃/3.5/0.2~1.3 | — | — | 1 + 2 |
| 2-5 | Fe₂O₃/50/0.5 | Cr₂O₃/1/0.1~0.5 | — | — | 1 + 2 |
| 2-6 | Fe/50/50 | Al(OH)₃/5.3/2.5 | — | — | 1 + 2 |
| 2-7 | Fe/50/50 | Cr₂O₃/3.5/0.1~0.5 | SiO₂/1.5/0.02~0.06 | — | 1 + 2 |
| 2-8 | Fe/50/50 | Cr₂O₃/3.5/0.1~0.5 | SiO₂/1.5/0.02~0.06 | Fe₂O₃/0.5/0.5 | 1 + 2 |

Note:
process 1 represents a hydrogenation condition of 5% H₂, 900° C. and reacts for 12 hrs; process 2 represents a sintering condition of an air atmosphere, 600° C. and reacts for 1 hr.

TABLE 4
Comparative Example 2

| | magnetic permeability | magnetic permeability |
|---|---|---|
| | @1 MHz | @10 MHz |
| 2-1 | 1 | 0.4 |
| 2-2 | 6 | 3 |

Example 2

| | magnetic permeability | magnetic permeability |
|---|---|---|
| number | @1 MHz | @10 MHz |
| 2-1 | 31 | 29 |
| 2-2 | 14 | 3 |
| 2-3 | 18 | 4 |
| 2-4 | 14 | 3 |
| 2-5 | 22 | 21 |
| 2-6 | 15 | 5 |
| 2-7 | 17 | 6 |
| 2-8 | 15 | 7 |

Referring to Tables 2 and 4, it can be found from the results of Comparative Examples 1-1 and 2-1 that although metal Fe has good magnetic permeability at first, the above property obviously becomes worse after the sintering process. Similarly, it can also be found from the results of Comparative Examples 1-2 and 2-2 that although the mixture of the first particles Fe and the second particles Cr₂O₃ has good magnetic permeability at first, the above property also obviously becomes worse after the sintering process. It can be found from Comparative Example 3 that the magnetic permeability of the mixture using ferric oxide (Fe₂O₃) as the first particles and using Cr₂O₃ as the second particles was not good.

It can be learned from the above that although using metal Fe as the first particles (for example, Comparative Examples 1-1, 1-2), the original good magnetic permeability of metal Fe was significantly affected after the sintering process (for example, Comparative Examples 2-1, 2-2). In addition, while ferric oxide (Fe₂O₃) was used as the first particles (for example, Comparative Example 1-3), the magnetic permeability was not good.

However, referring to Table 2, comparing Examples 1-1˜1-8 and Comparative Example 1-1, it can be found that the magnetic permeability (@10 MHz) of the mixture, which was formed by mixing the first particles (Fe, Fe₂O₃) and different second particles (Cr₂O₃, Al(OH)₃, SiO₂, Fe₂O₃) using a ball mill, was significantly increased after the hydrogenation process compared to that of Comparative Example 1-1. In addition, it can be further found by comparing the results of Examples 1-1˜1-8 and Comparative Examples 1-4 and 1-5 that the magnetic permeability (@1 MHz, @10 MHz) of the magnetic particles obtained in Examples 1-1˜1-5 was more excellent compared to Comparative Examples 1-4 and 1-5 which used Fe alloy (FeSi, FeNiMo) as the first particle. It is worth mentioning that although Fe₂O₃ was used as the first particles in Example 1-5, the magnetic permeability (@1 MHz, @10 MHz) was significantly increased after the hydrogenation compared to Comparative Example 1-3.

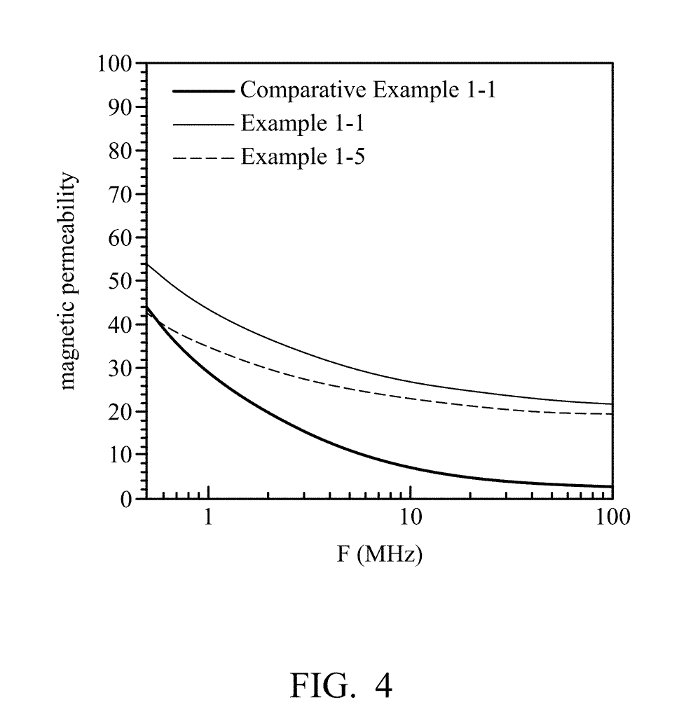

FIG. 4 illustrates the magnetic permeability of the magnetic materials of Comparative Example 1-1 and Examples 1-1, 1-5. It can be observed that, compared to Comparative Example 1-1, the magnetic permeability of Examples 1-1 and 1-5 were all increased at a high frequency (for example, 1 MHz-100 MHz).

Next, referring to Table 4, it can be found by comparing the results of Examples 2-1˜2-8 and Comparative Example 2-1 that the magnetic permeability (@1 MHz, @10 MHz) of the mixture, which was formed by mixing the first particles (Fe, Fe₂O₃) and different second particles (Cr₂O₃, Al(OH)₃, SiO₂, Fe₂O₃) using a ball mill, was significantly increased compared to that of comparative example 2-1, while a hydrogenation reaction was performed prior to the sintering process. In addition, it can be found by comparing the results of Examples 2-1˜2-8 and Comparative Example 2-2 that the magnetic permeability (@1 MHz) of the mixture, which was formed by mixing the first particles (Fe, Fe₂O₃) and different second particles (Cr₂O₃, Al(OH)₃, SiO₂, Fe₂O₃) using a ball mill, was significantly increased compared to that of comparative example 2-2, while a hydrogenation reaction was performed prior to the sintering process.

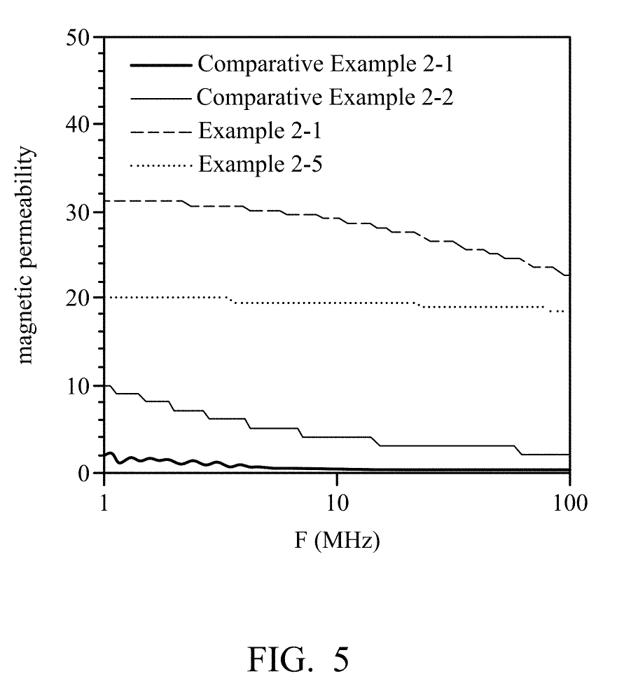

FIG. 5 illustrates the magnetic permeability of the magnetic materials of Comparative Examples 2-1, 2-2 and Examples 2-1, 2-5. It can be observed that, compared to Comparative Examples 2-1, 2-2, the magnetic permeability of Examples 2-1, 2-5 were all increased at a high frequency (for example, 1 MHz˜100 MHz).

### Scanning Electron Microscope (SEM) Observation Results

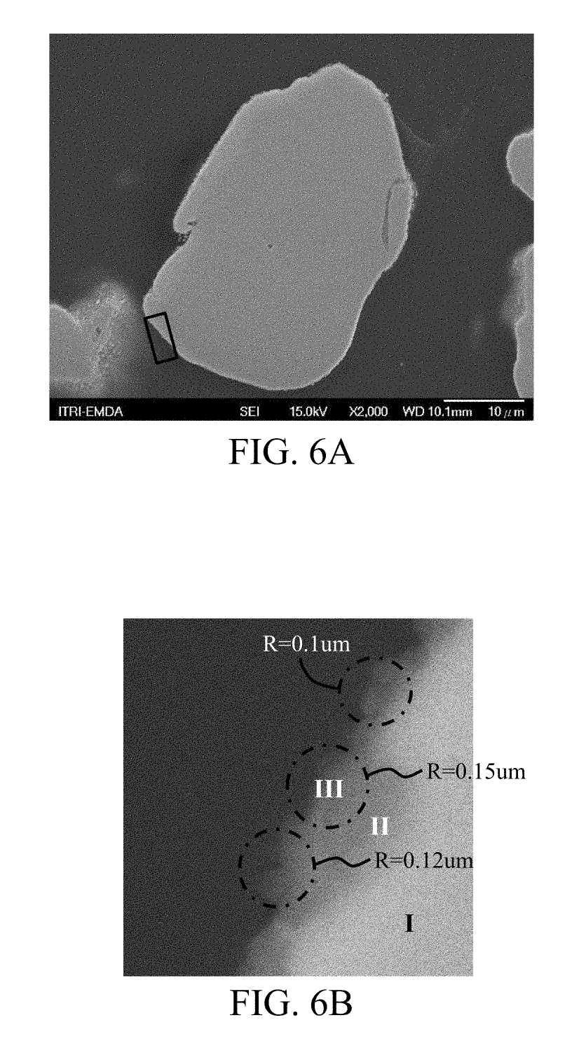

FIG. 6A illustrates a scanning electron microscope (SEM) cross-sectional schematic diagram of the magnetic material formed in Example 2-1. It can be observed that an alloy region is distributed evenly around the core portion. FIG. 6B is an enlarged diagram of the region indicated by the square frame shown in FIG. 6A. The region I is Fe, the region II is a passivation layer containing an oxide of FeCr, and the region III is a passivation layer containing an oxide of Cr (Cr₂O₃).

### EDS-Line Scan Results

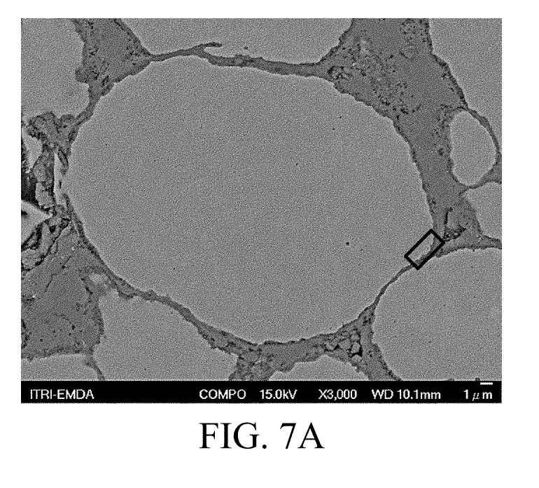

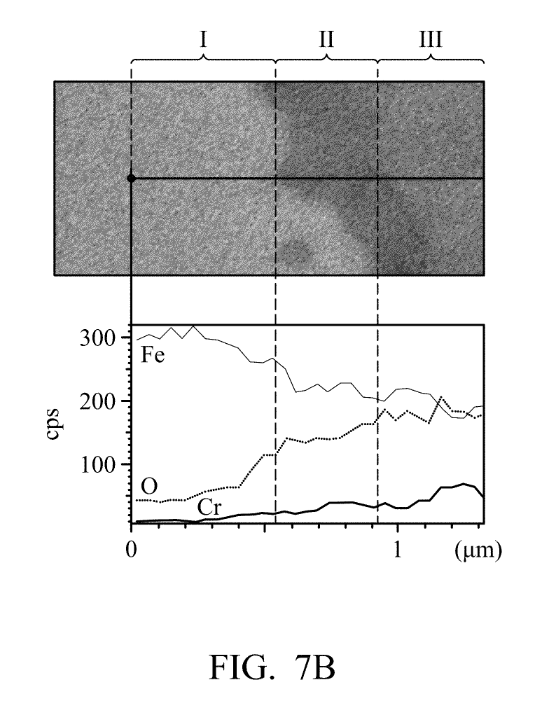

FIG. 7A illustrates a scanning electron microscope (SEM) cross-sectional schematic diagram of the magnetic material obtained in Example 2-1. FIG. 7B is an enlarged diagram of the region indicated by the square frame shown in FIG. 7A. After performing the EDS-Line Scan on the region shown in FIG. 7B, it was found that the region I near the center has the highest amount of Fe element and merely a small amount of Cr and O element. It was proved that the center of the magnetic material of the present disclosure consists almost entirely of Fe. In addition, it can also be observed that the amount of Cr gradually decreases from the region III to the center, which proves that Cr element in the magnetic material indeed diffuses from the region III to the region II. Also, as determined by the amount of O element, it can be deduced that the region II includes oxides of FeCr, and the region III includes oxides of Cr. In addition, the amount of Fe in the region III shown in FIG. 7B may be a result of the deviation of the detection positions during the process of the EDS-Line Scan. Theoretically, only a small amount of Fe diffuses from the region I near the center to the region II and the region III during the process of a thermal treatment.

### COMPARATIVE EXAMPLE 3

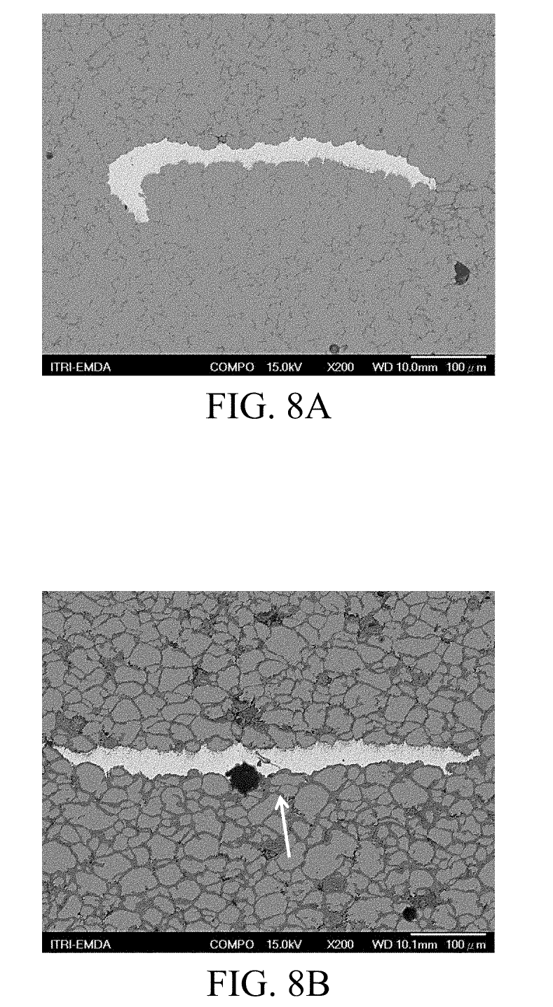

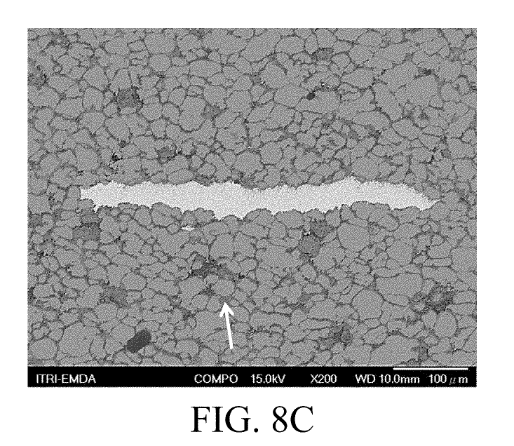

The magnetic material obtained in Comparative Example 1-1 was co-fired with silver at a sintering temperature of 600° C. to form a co-fired type inductor (molding conditions: a mold of ψ9 mm×ψ5 mm, heating to 600° C. and then keep sintering for 1 hr, and finally naturally cooling). FIG. 8A illustrates a SEM image of Comparative Example 3. It can be observed from FIG. 8A that there was no self-formed passivation layer formed.

### Example 3-1

The magnetic material obtained in Example 1-6 was co-fired with silver at a sintering temperature of 600° C. to form a co-fired type inductor (molding conditions: a mold of ψ9 mm×ψ5 mm, heating to 600° C. and then keep sintering for 1 hr, and finally naturally cooling). FIG. 8B illustrates a SEM image of Example 3-1. It can be observed from FIG. 8B that there was a self-formed passivation layer formed (indicated by the arrow).

### Example 3-2

The magnetic material obtained in Example 1-8 was co-fired with silver at a sintering temperature of 600° C. to form a co-fired type inductor (molding conditions: a mold of ψ9 mm×ψ5 mm, heating to 600° C. and then keep sintering for 1 hr, and finally naturally cooling). FIG. 8C illustrates a SEM image of Example 3-2. It can be observed from FIG. 8C that there was a self-formed passivation layer formed (indicated by the arrow).

The above results prove that a self-formed passivation layer is formed between the magnetic particle provided by the present disclosure and the metal (for example, silver) to insulate the magnetic particle with the metal. An effective inductor has been successfully formed.

While the present disclosure has been described by several embodiments above, the present disclosure is not limited to the disclosed embodiments. Those skilled in the art may make various changes and modifications without departing from the spirit and scope of the present disclosure. Therefore, the protected scope of the present disclosure should be indicated by the following appended claims.

What is claimed is:

1. A magnetic material, comprising:
a core portion comprising above 99 wt % of Fe, based on the total weight of the core portion;
an alloy layer disposed on the surface of the core portion, comprising a FeM alloy, wherein M is Cr, Si, Al, Ti, Zr, or a combination thereof; and
a hybrid layer disposed on the surface of the alloy layer, comprising M and an oxide of M.

2. The magnetic material as claimed in claim 1, wherein the oxide of Fe comprises ferrous oxide (FeO), ferric oxide (Fe₂O₃), ferroferric oxide (Fe₃O₄), or a combination thereof.

3. The magnetic material as claimed in claim 1, wherein the particle size of the magnetic material is 0.5˜110 μm.

4. The magnetic material as claimed in claim 1, wherein the amount of M in the alloy layer is 5˜80 wt %, based on the total weight of the FeM alloy.

5. The magnetic material as claimed in claim 1, wherein the thickness of the alloy layer is 0.05˜10 μm.

6. The magnetic material as claimed in claim 1, wherein the thickness of the hybrid layer is 0.05˜10 μm.

7. A magnetic material, comprising:
a core portion comprising above 99 wt % of Fe, based on the total weight of the core portion;
a first passivation layer disposed on the surface of the core portion, comprising an oxide of a FeM alloy, wherein M is Cr, Si, Al, Ti, Zr, or a combination thereof; and
a second passivation layer disposed on the surface of the first oxide layer, comprising an oxide of M.

8. The magnetic material as claimed in claim 7, wherein the oxide of Fe comprises ferrous oxide (FeO), ferric oxide (Fe₂O₃), ferroferric oxide (Fe₃O₄), or a combination thereof.

9. The magnetic material as claimed in claim 7, wherein the particle size of the magnetic material is 0.5˜110 μm.

10. The magnetic material as claimed in claim 7, wherein the amount of M in the first passivation layer is 5˜80 wt %, based on the total weight of the oxide of the FeM alloy.

11. The magnetic material as claimed in claim 7, wherein the thickness of the first passivation layer is 0.05˜10 μm.

12. The magnetic material as claimed in claim 7, wherein the thickness of the second passivation layer is 0.05˜10 μm.

13. A magnetic component, comprising a sintered product of a magnetic material and a metal, wherein the magnetic material comprises the magnetic material as claimed in claim 1.

14. The magnetic component as claimed in claim 13, wherein the magnetic component comprises a multilayer inductor, a wire-wound inductor, or an electromagnetic interference (EMI) inhibition component.

15. The magnetic component as claimed in claim 13, wherein the metal comprises silver, copper, or a combination thereof.

16. The magnetic component as claimed in claim 13, wherein the magnetic material in the sintered product is a powder monomer, a debris of the powder monomer, an aggregate of the powder monomer, or a combination thereof.
